(19) United States
(12) Patent Application Publication
(10) Pub. No.: US 2026/0168871 A1
(43) Pub. Date: Jun. 18, 2026

(54) FORCE SENSOR ASSEMBLY WITH STRESS ISOLATION

(71) Applicant: Schaeffler Technologies AG & Co. KG, Auburn Hills, MI (US)

(72) Inventors: Andrew B. Herrmann, Inverness, IL (US); Robert C. Kosberg, Grayslake, IL (US); David Manfredi, Arlington Heights, IL (US); Benjamin C. Lin, Northbrook, IL (US); Jeffrey Frye, Grayslake, IL (US); Jen-Huang Albert Chiou, Ponte Vedra, FL (US)

(73) Assignee: Schaeffler Technologies AG & Co. KG, Auburn Hills, MI (US)

(21) Appl. No.: 19/250,697

(22) Filed: Jun. 26, 2025

Related U.S. Application Data
(60) Provisional application No. 63/733,106, filed on Dec. 12, 2024.

(51) Int. Cl. G01L 1/26; G01L 1/18

(52) U.S. Cl. CPC G01L 1/26; G01L 1/18

(57) ABSTRACT

A force sensor assembly includes stress isolation features/geometry that blocks out unintended/off-axis forces/stress that would normally create an inaccurate force output. The force sensor assembly is a relatively low cost, high volume, weight minimizing design using robust automotive grade technology and is easily integrated into various applications due to a platform design approach. The piezoresistive MEMS are placed on stainless steel, which are minimized to allow for mass/cost reduction, therefore the other parts (PCB, element cover, customizable force bar) in the assembly are also minimized to allow for mass/cost reduction. The assembly is a simple 3-piece assembly that is easily integrated with minimal assembly processes. The automotive grade technology referenced is high pressure piezoresistive MEMS technology.

### CROSS-REFERENCE TO RELATED APPLICATIONS

This application claims the benefit of provisional application 63/733,106, filed Dec. 12, 2024. The disclosure of the above application is incorporated herein by reference.

### FIELD OF THE INVENTION

The invention relates generally to a force sensor assembly which reduces or eliminates the effects of a force which is eccentric to the axial direction of the force sensor assembly.

### BACKGROUND OF THE INVENTION

Typical force sensors are very sensitive and may provide inaccurate force output by sensing unintended forces/stress if not designed and integrated into applications without extremely custom high-cost designs.

Ideally, for some applications, it is desirable that an applied force be applied in the direction of a specific axis, which is perpendicular to a surface upon which the force sensors are mounted. However, the applied force may not always be applied to the surface upon which the force sensors are mounted in an exact perpendicular manner or may be eccentric to the axial direction. This may result in the force sensors providing an inaccurate measurement due to unintended off-axis forces.

Accordingly, there exists a need for a force sensor assembly which compensates for a force which is eccentric to the axial direction of the force sensor assembly.

### SUMMARY OF THE INVENTION

In an embodiment, the present invention is a force sensor assembly which prevents unintended and off-axis forces, and therefore minimizes or eliminates inaccurate force measurements, ensuring precise and reliable outputs.

The force sensor assembly of the present invention includes stress isolation features/geometry that minimize or eliminate unintended/off-axis forces/stress that would otherwise create an inaccurate force output.

The force sensor assembly of the present invention is a relatively low cost, high volume, weight minimizing design using robust automotive grade technology and is easily integrated into various applications due to a platform design approach. The piezoresistive MEMS are placed on stainless steel, which are minimized to allow for mass and cost reduction, therefore the other parts (PCB, element cover, customizable force bar) in the assembly are also minimized to allow for mass and cost reduction. The assembly is a simple 3-piece assembly that is easily integrated with minimal assembly processes.

The automotive grade technology referenced is high pressure piezoresistive MEMS technology.

In an embodiment, the present invention is a force bar assembly having a force bar receptacle, a mounting element, the force bar receptacle connected to the mounting element, a housing, the mounting element connected to the housing, and a sensing assembly connected to the mounting element. Force applied to the force bar receptacle is transferred to the mounting element and detected by the sensing assembly.

In an embodiment, the mounting element includes a body portion, a cylindrical wall integrally formed with and at least partially surrounding the body portion, and a recess disposed between the body portion and the cylindrical wall such that the cylindrical wall surrounds the recess. The force bar receptacle is at least partially disposed in the recess when the force bar receptacle is connected to the mounting element.

In an embodiment, the present invention is a first outer flange is integrally formed with the cylindrical wall, and a second outer flange integrally formed with the first outer flange. The second outer flange is in contact with an aperture of the housing and a protrusion formed as part of a bottom surface of the integrated mounting nut is in contact with and applies force to the second outer flange when the mounting element is connected to the housing.

In an embodiment, an outer conical surface is integrally formed as part of the second outer flange, and an angled surface integrally formed as part of the housing. The outer conical surface is in contact with an applies force to the angled surface when the mounting element is connected to the housing.

In an embodiment, a disk element integrally formed with the body portion on the opposite side of the body portion in relation to the cylindrical wall, and the sensing assembly is mounted to a mounting surface of the disk element.

In an embodiment, a contact surface is part of the mounting element, and as the distance between the mounting surface and the contact surface is increased the outer diameter of the disk element may be reduced.

In an embodiment the force bar assembly includes an integrated mounting nut, and at least a portion of the mounting element is compressed between the integrated mounting nut and the housing when the integrated mounting nut is connected to the housing.

In an embodiment, a mounting protrusion is integrally formed with the body portion such that the mounting protrusion extends out of the recess and is at least partially surrounded by the cylindrical wall, and the mounting protrusion extends through the integrated mounting nut when the integrated mounting nut is connected to the housing. In an embodiment a mounting projection is integrally formed as part of the force bar receptacle, and a mounting recess integrally formed as part of the mounting projection. The mounting protrusion is at least partially disposed in the mounting recess and the mounting projection extends through the integrated mounting nut when the force bar receptacle is connected to the mounting element.

In an embodiment, a threaded surface is integrally formed as part of the integrated mounting nut, and a threaded surface is integrally formed as part of the housing. The threaded surface integrally formed as part of the integrated mounting nut is engaged with the threaded surface integrally formed as part of the housing when the integrated mounting nut is connected to the housing.

In an embodiment, a hexagonal surface is adjacent the threaded surface integrally formed as part of the integrated mounting nut, and a tool is placed in contact with the hexagonal surface to rotate the integrated mounting nut into a secured position.

In an embodiment, the housing includes an aperture, and the integrated mounting nut, the mounting element, and the force bar receptacle are at least partially disposed in the aperture when the integrated amounting nut is attached to the housing.

In an embodiment, the sensing assembly includes a plurality of discrete quarter-bridge sensing elements which form a Wheatstone bridge circuit for detecting the force applied to the force bar receptacle.

In an embodiment, each of the plurality of discrete quarter-bridge sensing elements is a low-powered dual-bar serial sensing element.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a force sensor assembly, according to embodiments of the present invention;

FIG. 2 is an exposed view of a force sensor assembly, according to embodiments of the present invention;

FIG. 3 a perspective view of a disk element which is part of a force sensor assembly, according to embodiments of the present invention;

FIG. 4 is a perspective view of a sensing component mounted to a disk element which is part of a force sensor assembly, according to embodiments of the present invention;

FIG. 5A is a bottom view of a disk, with several sensing elements mounted to the disk, where the disk is part of a force sensor assembly, according to embodiments of the present invention;

FIG. 5B is a diagram of a sensing element, which is part of a force sensor assembly, according to embodiments of the present invention;

FIG. 6 is a bottom view of a disk, with several sensing elements mounted to the disk in an alternate orientation, where the disk is part of a force sensor assembly, according to embodiments of the present invention;

FIG. 7 is a sectional view taken along line 7-7 of FIG. 1;

FIG. 8 is an enlarged view of a portion of FIG. 7; and

FIG. 9 is a sectional view of a mounting element which is part of a force sensor assembly, according to embodiments of the present invention.

### DETAILED DESCRIPTION OF THE PREFERRED EMBODIMENTS

The following description of the preferred embodiment(s) is merely exemplary in nature and is in no way intended to limit the invention, its application, or uses.

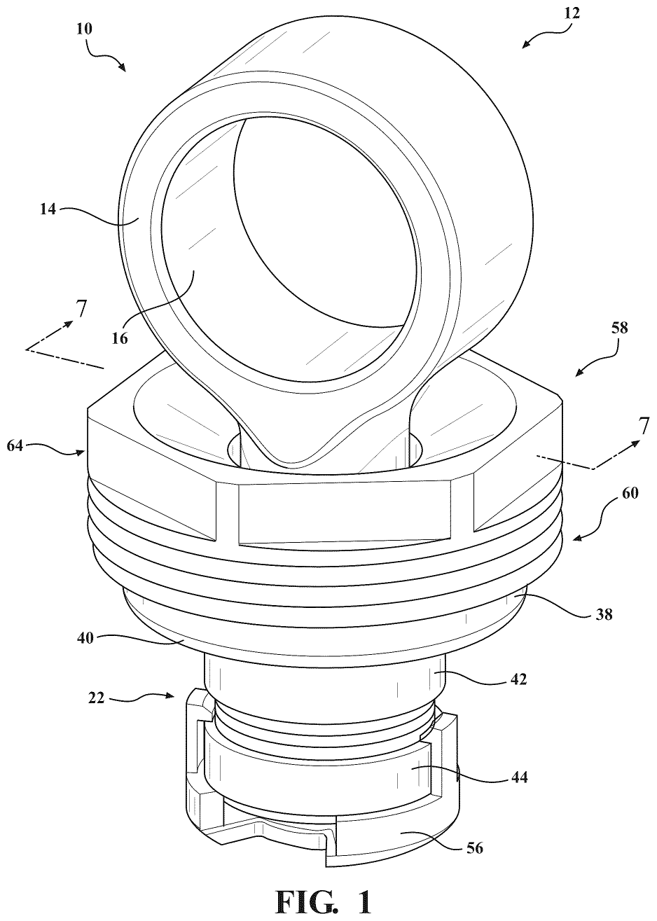

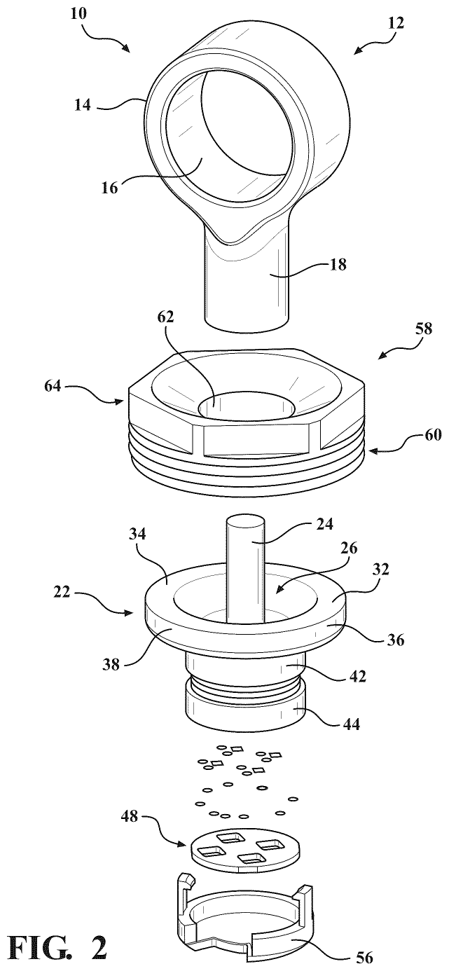

A force sensor assembly according to the present invention is shown in FIG. 1, generally at 10. Referring to the Figures generally, the force sensor assembly 10 includes a force bar receptacle, shown generally at 12, having a cylindrical wall 14 and an aperture 16 for receiving a force bar. Integrally formed with the cylindrical wall 14 is a mounting projection 18 having an aperture 20.

The force sensor assembly 10 also includes a mounting element, shown generally at 22. The mounting element 22 includes a mounting protrusion 24 extending out of a mounting recess, shown generally at 26. When assembled, the protrusion 24 at least partially extends into the aperture 20, connecting the force bar receptacle 12 to the mounting element 22. The connection between the protrusion 24 and the mounting projection 18 may be any suitable connection, such as press-fit, threaded, or the like. Surrounding the mounting recess 26 is a cylindrical wall 28, and integrally formed with the cylindrical wall 28 is a curved portion 30 of a mounting flange, shown generally at 32. The mounting flange 32 includes a first outer flange 34 which is integrally formed with the curved portion 30. The mounting flange 32 also includes a second outer flange 36, where the second outer flange 36 is perpendicular to the first outer flange 34. The second outer flange 36 has an outer circumferential surface 38, which is adjacent an outer conical surface 40. The cylindrical wall 28, the mounting flange 32 and mounting protrusion 24 are integrally formed with a body portion 42. Also integrally formed with the body portion 42 is a disk element 44 having a mounting surface 46.

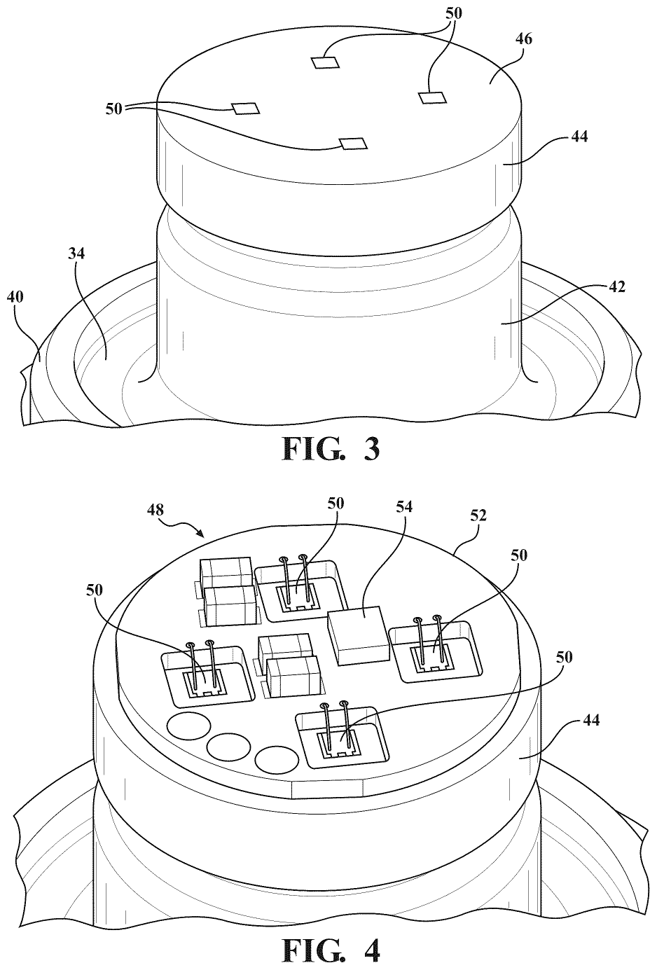

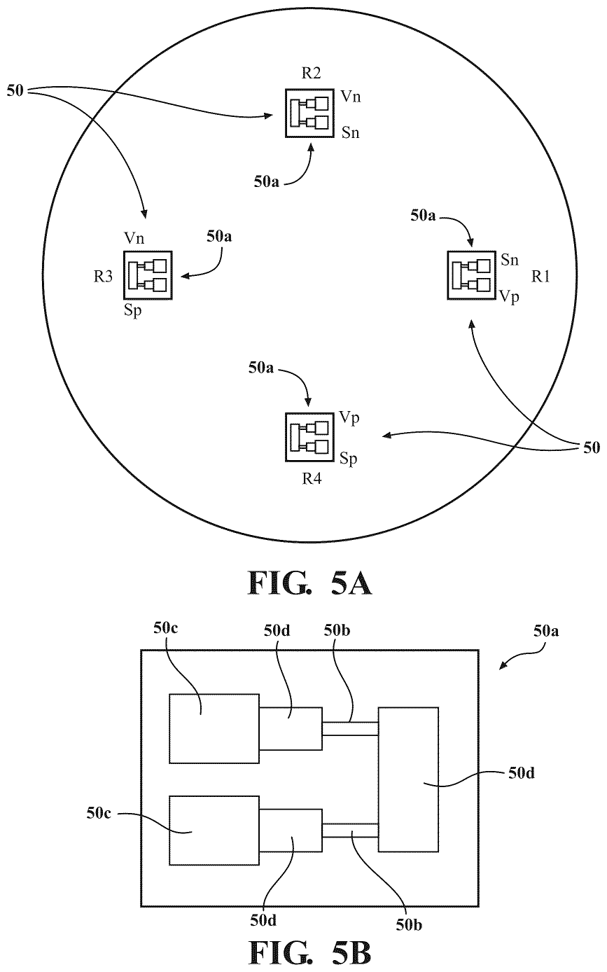

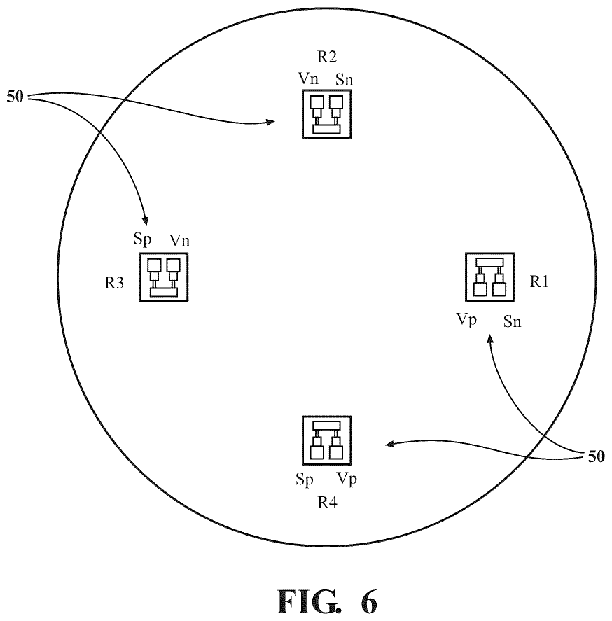

Referring to FIGS. 3-5B, mounted to the mounting surface 46 is a sensing assembly, shown generally at 48. The sensing assembly 48 includes several sensing elements 50 located on the mounting surface 46. The sensing assembly 48 also includes a printed circuit board (PCB) 52, and mounted to the PCB 52 is an ASIC 54. The ASIC 54 is in electrical communication with the sensing elements 50, and signals from the sensing elements 50 are conditioned by the ASIC 54 to create a calibrated and temperature compensated output signal. As shown in FIGS. 5A-5B, each of the sensing elements 50 includes a resistor 50a, and each resistor 50a includes two piezoresistors 50b and two bond pads 50c. The piezoresistors 50b and the bond pads 50c are in electrical communication with each other through the use of conductive interconnections 50d. In FIGS. 5A-5B, the resistors 50a have a first orientation, the resistors 50a may be configured in other orientations, an example of which is shown in FIG. 6.

Connected to the body portion 42 is an element cover 56. The element cover 56 protects the sensing assembly 48 from exposure to the elements.

The force sensor assembly 10 also incudes an integrated mounting nut, shown generally at 58. The integrated mounting nut 58 includes a threaded surface, shown generally at 60, which circumscribes the mounting nut 58, and an aperture 62. Adjacent the threaded surface 60 is a hexagonal surface 64, and adjacent the aperture 62 is a conical surface 66. Perpendicular to the threaded surface 60 is a protrusion 68, which extends from a bottom surface 70 of the integrated mounting nut 58.

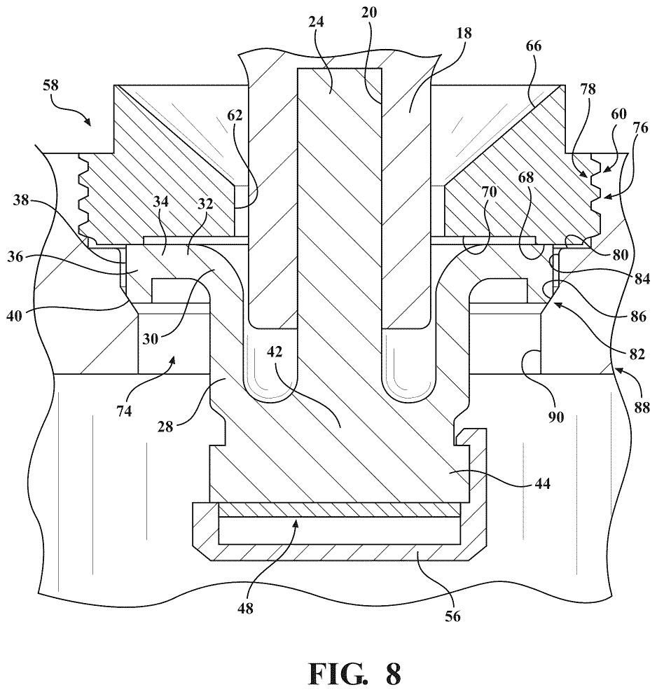

The force sensor assembly 10 is assembled to a housing 72. In the embodiment shown, the housing 72 includes an aperture, shown generally at 74. The aperture 74 has portions with different diameters. A first portion, shown generally at 76, of the aperture 74 has a threaded surface, shown generally at 78, which is perpendicular to a ridge portion 80, as shown in FIG. 8. A second portion, shown generally at 82 includes a first sidewall 84, and an angled wall 86 which is adjacent the first sidewall 84. The aperture 74 has a third portion, shown generally at 88, which has a second sidewall 90.

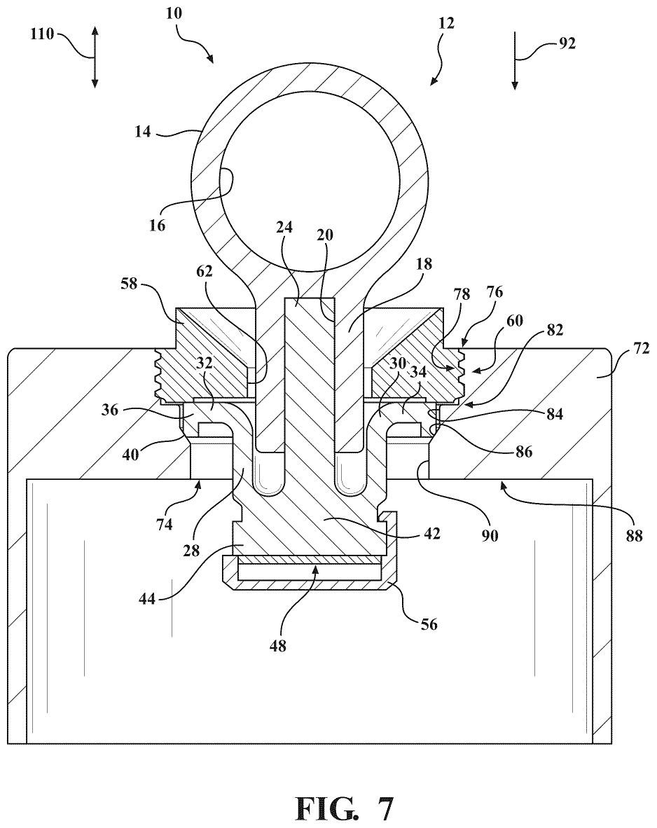

During assembly, the integrated mounting nut 58 is rotated to engage the threaded surface 60 of the integrated mounting nut 58 to the threaded surface 78 of the housing 72. The integrated mounting nut 58 is rotated by a tool that is clamped or engaged with the hexagonal surface 64. As the integrated mounting nut 58 is rotated, the integrated mounting nut 58 moves in the direction of the arrow 92 (shown in FIG. 7), such that force is applied from the protrusion 68 to the second outer flange 36, which results in the outer conical surface 40 formed as part of the second outer flange 36 applying force to the angled surface 86 of the aperture 74. The force applied to the mounting element 22 by the integrated mounting nut 58 secures the force sensor assembly 10 in place. This connection between the integrated mounting nut 58, the mounting element 22, and the housing 72 also creates an environmental seal, eliminating the need for O-rings or other materials. Furthermore, the outer conical surface 40 formed as part of the second outer flange 36 applying force to the angled surface 86 of the aperture 74 functions as a stress isolation mechanism.

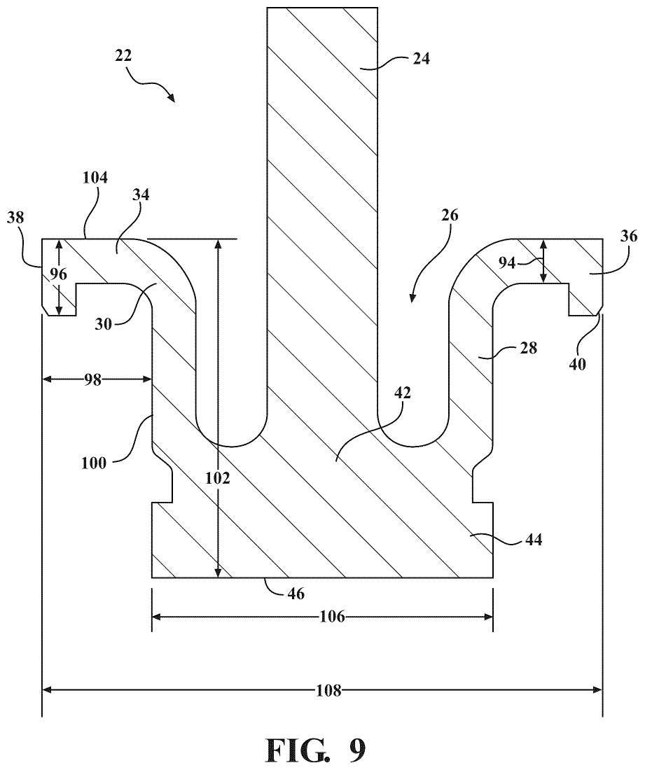

The connection between the mounting element 22, the integrated mounting nut 58, and the housing 72 provides for stress isolation geometry. More specifically, there are several dimensions which reduce or eliminate unintended off-axis forces or stress which typically result in inaccurate force output. One of the dimensions is the thickness 94 of the first outer flange 34, and another of the dimensions is the thickness 96 of the second outer flange 36. Another dimension is the distance 98 between the outer surface 100 of the cylindrical wall 28 and the outer circumferential surface 38. Another of the dimensions is the distance 102, as shown in FIG. 9, between the mounting surface 46 of the disk element 44 and a contact surface 104, where the contact surface 104 extends across both the first outer flange 34 and the second outer flange 36. Another of the dimensions is the outer diameter 106 (shown in FIG. 9) of the disk element 44, and the outer diameter 108 (shown in FIG. 9) of the outer circumferential surface 38. It various embodiments of the present invention, depending upon packaging limitations, the distance 102 may be increased, allowing for the outer diameter 106 of the disk element 44 and the outer diameter 108 of the outer circumferential surface 38 to be decreased.

During operation, force is applied to the force sensor assembly 10 in either direction of the arrows, indicated at 110 (shown in FIG. 7). The force 110 is applied from a bar or beam inserted into and connected to the force bar receptacle 12. The force 110 is applied to the force sensor assembly 10 causes the mounting element 22, and more specifically the disk element 44, to deflect. This deflection is detected by the sensing assembly 48. The ASIC 54 then sends a signal which corresponds to the magnitude of deflection of the disk element 44.

In other embodiments, the size of the disk element 44 may be larger or smaller to facilitate the force sensor assembly 10 being used for different force ranges.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus, comprising:
a force bar assembly, including:
a force bar receptacle;
a mounting element, the force bar receptacle connected to the mounting element;
a housing, the mounting element connected to the housing; and
a sensing assembly connected to the mounting element;
wherein force applied to the force bar receptacle is transferred to the mounting element and detected by the sensing assembly.

2. The apparatus of claim 1, the mounting element further comprising:
a body portion;
a cylindrical wall integrally formed with and at least partially surrounding the body portion; and
a recess disposed between the body portion and the cylindrical wall such that the cylindrical wall surrounds the recess;
wherein the force bar receptacle is at least partially disposed in the recess when the force bar receptacle is connected to the mounting element.

3. The apparatus of claim 2, further comprising:
a first outer flange integrally formed with the cylindrical wall; and
a second outer flange integrally formed with the first outer flange;
wherein the second outer flange is in contact with an aperture of the housing and a protrusion formed as part of a bottom surface of the integrated mounting nut is in contact with and applies force to the second outer flange when the mounting element is connected to the housing.

4. The apparatus of claim 3, further comprising:
an outer conical surface integrally formed as part of the second outer flange; and
an angled surface integrally formed as part of the housing;
wherein the outer conical surface is in contact with an applies force to the angled surface when the mounting element is connected to the housing.

5. The apparatus of claim 2, further comprising:
a disk element integrally formed with the body portion on the opposite side of the body portion in relation to the cylindrical wall;
wherein the sensing assembly is mounted to a mounting surface of the disk element.

6. The apparatus of claim 5, further comprising:
a contact surface being part of the mounting element;
wherein as the distance between the mounting surface and the contact surface is increased, the outer diameter of the disk element may be reduced.

7. The apparatus of claim 2, further comprising:
an integrated mounting nut;
wherein at least a portion of the mounting element is compressed between the integrated mounting nut and the housing when the integrated mounting nut is connected to the housing.

8. The apparatus of claim 7, further comprising:
a mounting protrusion integrally formed with the body portion such that the mounting protrusion extends out of the recess and is at least partially surrounded by the cylindrical wall, and the mounting protrusion extends through the integrated mounting nut when the integrated mounting nut is connected to the housing;
a mounting projection integrally formed as part of the force bar receptacle; and
a mounting recess integrally formed as part of the mounting projection;
wherein the mounting protrusion is at least partially disposed in the mounting recess and the mounting projection extends through the integrated mounting nut when the force bar receptacle is connected to the mounting element.

9. The apparatus of claim 7, further comprising:
a threaded surface integrally formed as part of the integrated mounting nut; and
a threaded surface integrally formed as part of the housing;
wherein the threaded surface integrally formed as part of the integrated mounting nut is engaged with the threaded surface integrally formed as part of the housing when the integrated mounting nut is connected to the housing.

10. The apparatus of claim 9, further comprising:
a hexagonal surface adjacent the threaded surface integrally formed as part of the integrated mounting nut;
wherein a tool is placed in contact with the hexagonal surface to rotate the integrated mounting nut into a secured position.

11. The apparatus of claim 7, the housing further comprising:
an aperture;
wherein the integrated mounting nut, the mounting element, and the force bar receptacle are at least partially disposed in the aperture when the integrated amounting nut is attached to the housing.

12. The apparatus of claim 1, the sensing assembly further comprising:
a plurality of discrete quarter-bridge sensing elements which form a Wheatstone bridge circuit for detecting the force applied to the force bar receptacle.

13. The apparatus of claim 12, wherein each of the plurality of discrete quarter-bridge sensing elements is a low-powered dual-bar serial sensing element.

14. A force sensor assembly, comprising:
a force bar receptacle;
a mounting element, the force bar receptacle connected to the mounting element;
a housing, the mounting element connected to the housing;
a sensing assembly connected to the mounting element;
an integrated mounting nut attached to the housing such that the integrated mounting nut compresses the mounting element between the integrated mounting nut and the housing; and
an aperture integrally formed as part of the integrated mounting nut, such that a portion of the mounting element and a portion of the force bar receptacle extend through the aperture when the force bar receptacle is attached to the mounting element and the integrated mounting nut is attached to the housing;
wherein force applied to the force bar receptacle is transferred to the mounting element and detected by the sensing assembly.

15. The force sensor assembly of claim 14, the mounting element further comprising
a body portion;
a cylindrical wall integrally formed with and at least partially surrounding the body portion;
a recess disposed between the body portion and the cylindrical wall such that the cylindrical wall surrounds the recess;
a mounting protrusion integrally formed with the body portion such that the mounting protrusion extends out of the recess and is at least partially surrounded by the cylindrical wall; and
a disk element integrally formed as part of the body portion on the opposite side of the body portion in relation to the cylindrical wall, and the sensing assembly is mounted to a mounting surface of the disk element;
wherein the mounting protrusion extends through the aperture of the integrated mounting nut and is attached to the force bar receptacle.

16. The force sensor assembly of claim 15, further comprising:
a mounting projection integrally formed with the force bar receptacle; and
a mounting recess integrally formed as part of the mounting projection;
wherein the mounting protrusion is at least partially disposed in the mounting recess, and the mounting projection extends through the aperture of the integrated mounting nut when the force bar receptacle is connected to the mounting element.

17. The force sensor assembly of claim 15, further comprising:
a first outer flange integrally formed with the cylindrical wall;
a second outer flange integrally formed with the first outer flange;
an outer conical surface integrally formed as part of the second outer flange; and
an angled surface integrally formed as part an aperture of the housing;
wherein the outer conical surface is in contact with the angled surface when the mounting element is connected to the housing.

18. The force sensor assembly of claim 17, further comprising:
a contact surface being part of the first outer flange and the second outer flange;
wherein as the distance between the mounting surface and the contact surface is increased and the outer diameter of the disk element and the outer diameter of the second outer flange may be reduced.

19. The force sensor assembly of claim 15, further comprising
a threaded surface integrally formed as part of the integrated mounting nut;
a threaded surface integrally formed as part of the housing;
a protrusion formed as part of a bottom surface of the integrated mounting nut such that the protrusion is adjacent the threaded surface integrally formed as part of the integrated mounting nut;
wherein the threaded surface integrally formed as part of the integrated mounting nut is engaged with the threaded surface integrally formed as part of the housing and the protrusion is in contact with the second outer flange of the mounting element when the integrated mounting nut is connected to the housing.

20. The force sensor assembly of claim 19, the housing further comprising:
an aperture;
wherein the integrated mounting nut, the mounting element, and the force bar receptacle at least partially disposed in the aperture of the housing.

21. The force sensor assembly of claim 14, wherein the sensing assembly further comprising:
a plurality of discrete quarter-bridge sensing elements which form a Wheatstone bridge circuit for detecting the force applied to the force bar receptacle.

22. The force sensor assembly of claim 21, wherein each of the plurality of discrete quarter-bridge sensing elements is a low-powered dual-bar serial sensing element.
